(19) United States
(12) Patent Application Publication
(10) Pub. No.: US 2025/0200373 A1
(43) Pub. Date: Jun. 19, 2025

(54) UNSTRUCTURED PRUNING FOR MULTI-LAYER PERCEPTRONS WITH TANH ACTIVATION

(71) Applicant: UNIVERSITY OF SOUTH FLORIDA, Tampa, FL (US)

(72) Inventors: Srinivas KATKOORI, Tampa, FL (US); Kavya Lakshmi KALYANAM, Tampa, FL (US)

(21) Appl. No.: 18/981,297

(22) Filed: Dec. 13, 2024

Related U.S. Application Data
(60) Provisional application No. 63/609,623, filed on Dec. 13, 2023.

(51) Int. Cl. G06N 3/082; G06N 3/048

(52) U.S. Cl. CPC G06N 3/082; G06N 3/048

(57) ABSTRACT

Systems and methods for optimizing a trained neural network model are provided herein. A trained neural network model is obtained. The trained neural network model comprises a plurality of neurons. A plurality of output information of the hidden layers is received by performing a simulation of the trained neural network using a dataset. A plurality of mean activation values corresponding to neurons of the plurality of hidden layers is calculated, based on using a hyperbolic tangent (tanh) activation function. A subset of mean values corresponding to a plurality of ranges is calculated. A plurality of neurons and a plurality of associated layers corresponding to the subset of mean values is modified. An optimized neural network model that implements the modified plurality of neurons and the modified plurality of associated layers is generated.

### CROSS REFERENCE TO RELATED APPLICATIONS

This application claims priority to U.S. provisional patent application No. 63/609,623, filed Dec. 13, 2023, the entire content of which is incorporated herein by reference.

### STATEMENT OF GOVERNMENT SUPPORT

None.

### BACKGROUND

Neural networks consist of layers of interconnected artificial neurons that process and transform input data. The architecture of neural networks, often designed to mimic the hierarchical organization of features in data, has evolved to encompass diverse structures such as convolutional neural networks (CNNs), recurrent neural networks (RNNs), and transformers.

While neural network research has primarily focused on designing and training effective architectures, the efficient deployment of these models on hardware platforms presents a new set of challenges. The inherent parallelism in neural networks can be effectively harnessed by hardware accelerators, enabling significant speedup over traditional processors. Furthermore, hardware-specific optimizations can minimize energy consumption, reduce memory bottlenecks, and cater to real-time requirements, making neural networks practical for applications such as self-driving cars, healthcare devices, and edge computing.

Deep neural networks can be used in contemporary artificial intelligence, exhibiting performance across diverse domains such as computer vision, natural language processing, and autonomous systems. However, the proliferation of increasingly complex models has led to heightened computational demands and memory footprints, raising concerns regarding their scalability and practicality. There are several methods for optimizing neural networks (NN) for edge devices, including weight clustering, pruning for sparsity, and quantization for reduced bit-width. Hardware-aware optimization, such as model co-design and dynamic reconfiguration, tailors networks to specific accelerators, ensuring efficient execution on edge devices.

The technique of neural network pruning has emerged as a critical strategy to mitigate these resource-intensive challenges. Pruning aims to surgically reduce model size while retaining or even enhancing its predictive accuracy by excising extraneous connections, neurons, or weights. This reduction in superfluous parameters not only mitigates computational costs but also facilitates deployment on resource-constrained platforms and accelerates inference. The removal of neurons or weights, often driven by heuristic criteria, can lead to an unforeseen degradation in model performance. While pruning addresses model sparsity by eliminating unnecessary connections, quantization significantly reduces the precision of numerical values, collectively leading to more streamlined and resource-efficient models.

Deep learning models can be computationally expensive to train and deploy, and they can also consume a lot of energy. The challenges posed by IoT and edge computing environments for network pruning may include limited computation resources, memory constraints, and energy-efficiency requirements. Therefore, there is a need for pruning methods that are both efficient and effective in resource-constrained environments.

### SUMMARY

The following presents a simplified summary of the disclosed technology herein in order to provide a basic understanding of some aspects of the disclosed technology. This summary is not an extensive overview of the disclosed technology. It is intended neither to identify key or critical elements of the disclosed technology nor to delineate the scope of the disclosed technology. Its sole purpose is to present some concepts of the disclosed technology in a simplified form as a prelude to the more detailed description that is presented later.

In some aspects, the present disclosure can provide a method for optimizing a trained neural network model, the method comprising: obtaining a trained neural network model, the trained neural network model comprising a plurality of neurons and a plurality of hidden layers; determining a simulation dataset having a set of data characteristics common to data characteristics of a training dataset on which the trained neural network was trained; receiving a plurality of output information of the hidden layers by running the trained neural network on the simulation dataset, wherein the output information is indicative of activations of the neurons while running on the simulation dataset; calculating a plurality of mean activation values corresponding to the plurality of output information, the mean activation values having been determined according to a hyperbolic tangent (tanh) activation function; determining a subset of the plurality of neurons for which the mean activation values corresponded to one of at least two ranges of activation values; modifying the subset of the plurality of neurons and a plurality of associated layers corresponding to the subset of the plurality of neurons; and generating an optimized neural network model that implements the modified plurality of neurons and the modified plurality of associated layers as well as neurons of the trained neural network that were not modified.

In further aspects, the present disclosure can provide a system for neural network optimization, the system comprising: an electronic processor, and a non-transitory computer-readable medium storing machine-executable instructions, which, when executed by the electronic processor, cause the electronic processor to: obtain a trained neural network model, the trained neural network model comprising a plurality of neurons and a plurality of hidden layers; determine a simulation dataset having a set of data characteristics common to data characteristics of a training dataset on which the trained neural network was trained; receive a plurality of output information of the hidden layers by running the trained neural network on a simulation dataset, wherein the output information is indicative of activations of the neurons while running on the simulation dataset; calculate a plurality of mean activation values corresponding to the plurality of outputs information, the mean activation values having been determined according to a hyperbolic tangent (tanh) activation function; determine a subset of the plurality of neurons for which the mean activation values corresponded to one of at least two ranges of activation values; modify the subset of the plurality of neurons and a plurality of associated layers corresponding to the subset of the plurality of neurons; and generate an optimized neural network model that implements the modified plurality of neurons and the modified plurality of associated layers as well as neurons of the trained neural network that were not modified.

### BRIEF DESCRIPTION OF THE DRAWINGS

The foregoing features of embodiments will be more readily understood by reference to the following detailed description, taken with reference to the accompanying drawings, in which:

FIG. 1 illustrates an example deep neural network architecture with two hidden layers according to some embodiments.

FIG. 2 is an example plot of a hyperbolic tangent (tanh) activation function according to some embodiments.

FIG. 3 is a block diagram conceptually illustrating an example hardware system for neural network optimization according to some embodiments.

FIG. 4 is a flowchart illustrating an example process for mean based optimization according to some embodiments.

FIG. 5 is a chart illustrating an example comparison of breast cancer dataset accuracy according to some embodiments.

FIG. 6 is a chart illustrating an example comparison of MNIST accuracy with respect to a number of neurons pruned according to some embodiments.

### DETAILED DESCRIPTION

As used in this specification and the claims, the singular forms “a,” “an,” and “the” include plural forms unless the context clearly dictates otherwise.

As used herein, “about”, “approximately,” “substantially,” and “significantly” will be understood by persons of ordinary skill in the art and will vary to some extent on the context in which they are used. If there are uses of the term which are not clear to persons of ordinary skill in the art given the context in which it is used, “about” and “approximately” will mean up to plus or minus 10% of the particular term and “substantially” and “significantly” will mean more than plus or minus 10% of the particular term.

As used herein, the terms “include” and “including” have the same meaning as the terms “comprise” and “comprising.” The terms “comprise” and “comprising” should be interpreted as being “open” transitional terms that permit the inclusion of additional components further to those components recited in the claims. The terms “consist” and “consisting of” should be interpreted as being “closed” transitional terms that do not permit the inclusion of additional components other than the components recited in the claims. The term “consisting essentially of” should be interpreted to be partially closed and allowing the inclusion only of additional components that do not fundamentally alter the nature of the claimed subject matter.

The phrase “such as” should be interpreted as “for example, including.” Moreover, the use of any and all exemplary language, including but not limited to “such as”, is intended merely to better illuminate the invention and does not pose a limitation on the scope of the invention unless otherwise claimed.

Furthermore, in those instances where a convention analogous to “at least one of A, B and C, etc.” is used, in general such a construction is intended in the sense of one having ordinary skill in the art would understand the convention (e.g., “a system having at least one of A, B and C” would include but not be limited to systems that have A alone, B alone, C alone, A and B together, A and C together, B and C together, and/or A, B, and C together.). It will be further understood by those within the art that virtually any disjunctive word and/or phrase presenting two or more alternative terms, whether in the description or figures, should be understood to contemplate the possibilities of including one of the terms, either of the terms, or both terms. For example, the phrase “A or B” will be understood to include the possibilities of “A” or “B” or “A and B.”

All language such as “up to,” “at least,” “greater than,” “less than,” and the like, include the number recited and refer to ranges which can subsequently be broken down into ranges and subranges. A range includes each individual member. Thus, for example, a group having 1-3 members refers to groups having 1, 2, or 3 members. Similarly, a group having 6 members refers to groups having 1, 2, 3, 4, or 6 members, and so forth.

The modal verb “may” refers to the preferred use or selection of one or more options or choices among the several described embodiments or features contained within the same. Where no options or choices are disclosed regarding a particular embodiment or feature contained in the same, the modal verb “may” refers to an affirmative act regarding how to make or use an aspect of a described embodiment or feature contained in the same, or a definitive decision to use a specific skill regarding a described embodiment or feature contained in the same. In this latter context, the modal verb “may” has the same meaning and connotation as the auxiliary verb “can.”

Various embodiments, configurations, materials, devices, systems, methods, and techniques for unstructured pruning are disclosed herein. With respect to the devices and systems described below, certain alternative components and materials are described, none of which are intended to be limiting or required. The description of components of such devices and systems is intended to be illustrative only, and neither a minimum nor limit of the types of components that could be used in various embodiments hereof. Similarly, the methods described herein are explained with reference to optional steps and modifications, none of which are intended to be limiting or required. The methods described herein can be performed using hardware such as (or including) the devices and systems described herein but need not be implemented through such hardware except in specific examples that identify the use of such hardware.

Generally speaking, neural networks can be constructed to have architectures that differ in several basic was. For example, some neural networks may be referred to as “feedforward neural networks” (FNNs), in that data primarily flows through the networks in one direction (from input to output) often without cycles or loops. In contrast, “recurrent neural networks” (RNNs) may involve inherent “memory” or capture of information from previous time steps. As another example, neural networks can be classified as “deep neural networks” (DNNs) in that they may comprise multiple layers, such as in CNNs, MLPs, and Transformer networks (e.g., they may include multiple “hidden” layers, pooling layers, fully connected layers, etc.)

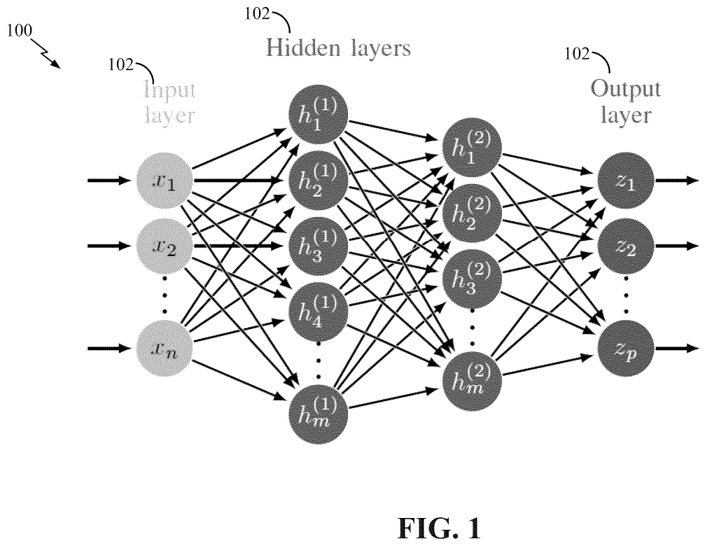

The Multiplayer Perceptron (MLP) architecture is a building block of DNNs in many IoT and edge computing applications, and was one of the first categories of neural networks to be developed. MLPs share many common attributes of more recently-developed architectures, such as CNNs, RNNs, LSTMs, etc., and thus will be used in the present disclosure as a framework for describing various systems and methods. FIG. 1 illustrates a conceptual example of a DNN MLP architecture 100 with two hidden layers 102—it should be understood, however, that actual MLPs could have more layers (and/or more types of layers) than shown in FIG. 1. As shown in FIG. 1, the neural network may comprise a number of different input channels x₁ to xₙ that are provided to an input layer 102, which then provide the inputs to the nodes h₁⁽¹⁾ hₙ⁽¹⁾ of a first hidden layer 102, which are then connected to nodes of a second hidden layer, followed by an output layer. Thus, as shown, the hidden layers 102 comprise multiple layers of interconnected nodes, capable of handling complex tasks. As depicted, each input is connected to each node of the first hidden layer, and each node of the first hidden layer is connected to each node of the second hidden layer. However, in other architectures, such as CNNs, each node may not necessarily be connected to all other nodes, and in yet further architectures, such as RNNs, nodes may be connected to subsequent and/or prior nodes.

“Pruning” of neural networks is an approach by which developers seek to optimize one or more attributes of the neural network by modifying, culling, or pruning neurons, weights, or other components according to a system that seeks to balance performance and accuracy considerations. Pruning can be broadly classified as structured and unstructured pruning. In some examples, structured pruning can involve removing groups of units or connections from a network, which may be done based on the connectivity of the network or the importance of the units or connections. Unstructured pruning may involve the removal of individual connections or weights without adhering to a predetermined pattern. Unstructured pruning may entail the identification and elimination of connections or weights that contribute minimally to the overall network performance and can be determined based on factors such as magnitude or importance scores.

There are several different network pruning techniques, including weight magnitude pruning, neuron pruning, filter, and channel pruning. Weight Magnitude Pruning may include weights with smaller magnitudes, which contribute less to the overall model and can be pruned without significantly affecting performance. Neuron Pruning identifies and prunes neurons with minimal impact on the network's performance. Adaptive Pruning adapts to the changing characteristics of the network during training for optimal pruning. Channel Pruning involves removing entire channels (i.e., sets of feature maps) in convolutional layers. Random Pruning introduces a stochastic element to pruning for exploration of different network configurations. The selection of a pruning method hinges on multiple factors, such as the model architecture, desired accuracy, and available computational resources.

As will be described below, the inventors have developed a new approach to pruning neural networks, which leverages the hyperbolic tangent function. The hyperbolic tangent (tanh) activation function is a non-linear function. Tanh takes an input value and computes a function that will have output values ranging from −1 to 1, and its mean or average value is close to zero. Mathematically, the tanh function is expressed as:

$$tan h ( x ) = \frac{{e}^{x} - {e}^{- x}}{{e}^{x} + {e}^{- x}} . \qquad Equation 1$$

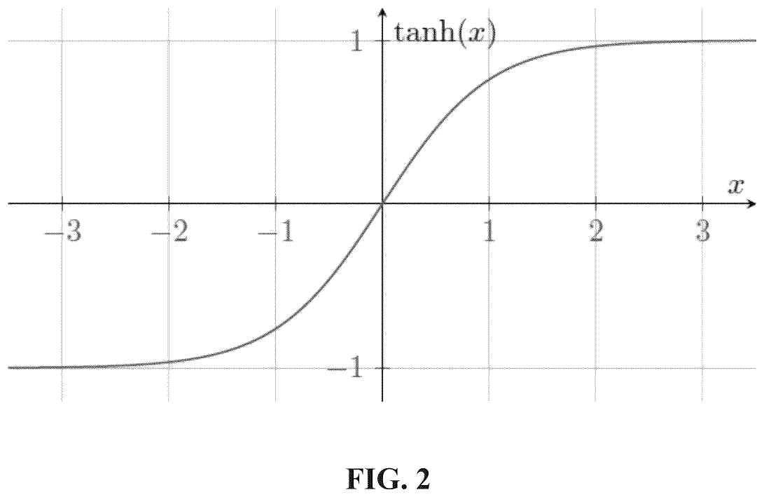

The output of the function is centered around zero when the input is close to zero Equation 2: tanh(0)=0. This property is particularly advantageous during neural network training, as it helps mitigate the vanishing gradient problem, facilitating faster convergence. The tanh activation function can help mitigate the vanishing gradient problem to some extent. Unlike the sigmoid function, which saturates at 0 and 1, the tanh function has a range between −1 and 1, as shown in FIG. 2. This broader range helps address the vanishing gradient issue because the derivatives of tanh are generally larger than those of the sigmoid, particularly for inputs close to zero.

### Hardware Configurations and Embodiments

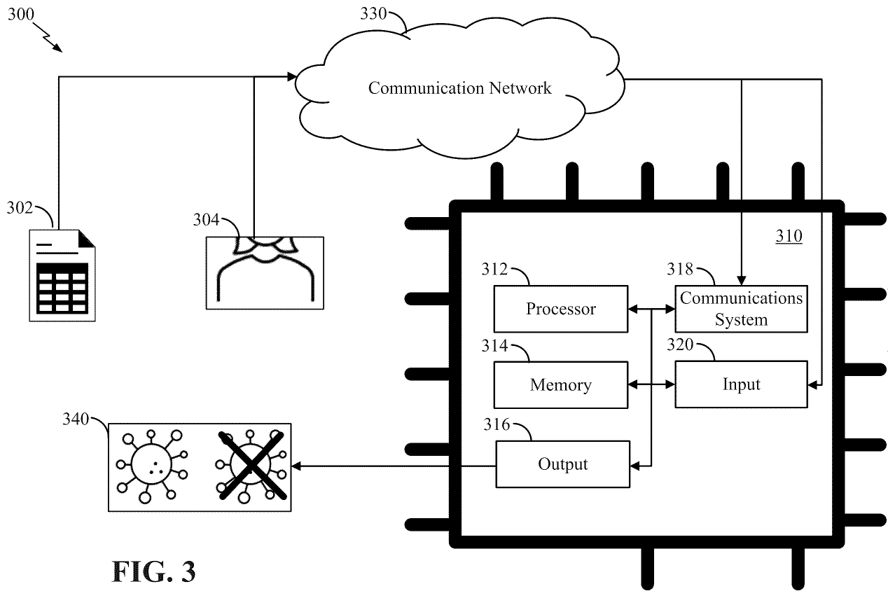

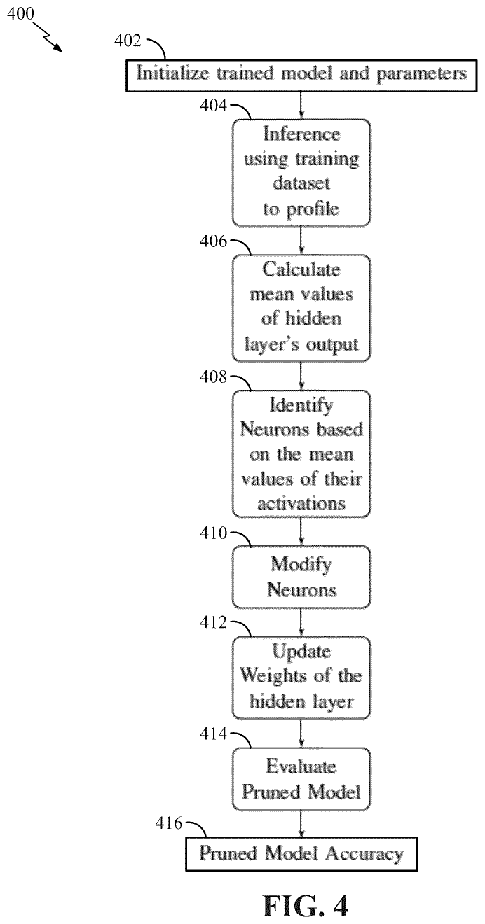

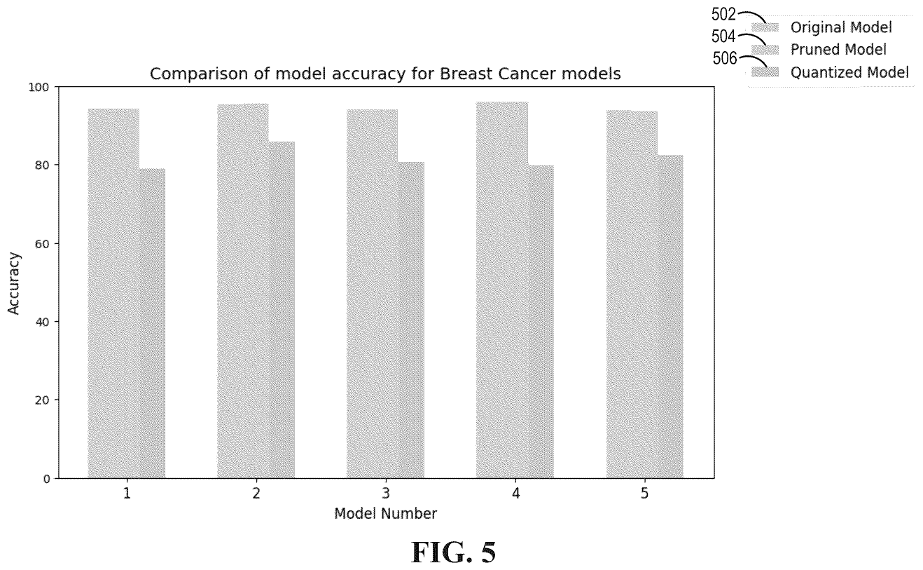

FIG. 3 shows a block diagram illustrating a system 300 for optimization for a neural network model according to some embodiments. The computing device 310 can be an integrated circuit (IC), a computing chip, or any suitable computing device that is able to compute large amounts of computations in parallel, as would be involved in deploying a deep neural network. In some examples, the computing device 310 can be a special purpose device to implement a neural network model, such as an ASIC that is developed to run a given neural network, or a GPU that is developed to efficiently run deep neural networks on training or sample sets in order to monitor neuron activity. Thus, the process 400 or 500 described in FIG. 4 or 5 can be tied to a special purpose device.

In the system 300, a computing device 310 can obtain or receive a dataset. In some examples, the dataset may support preprocessing methods such as cleaning, normalizing, scaling, and augmentation. During preprocessing, features from the dataset may be derived directly from raw data or extracted. The dataset can further include ground-truth labels. In some examples, the dataset may represent a diverse set of data and contain a balanced distribution of classes or case/control ratios to avoid bias and maintain model performance. For example, techniques such as sequence compaction and vector compaction may be applied to reduce the dimensionality of data, eliminate redundancy, and/or enhance storage, transmission, and processing efficiency. For example, in some experiments performed by the inventors, the dataset used was a Modified National Institute of Standards and Technology (MNIST) dataset 302 or a breast cancer dataset 304, or any other suitable dataset for benchmarking and validation. For example, the dataset can include an image, a medical record, X-ray data, magnetic resonance imaging (MRI) data, computed tomography (CT) data, or any other suitable data for classification. In other examples, the dataset can include one or more features extracted from input data. Also, in some examples, the dataset can include a training dataset to be used to optimize hardware for a neural network model. In some examples, the dataset can be produced by one or more sensors or devices (e.g., X-ray imaging machine, CT machine, MRI machine, a cell phone, or any other suitable devices). In some examples, the dataset can be directly applied to the neural network model. In other examples, one or more features can be extracted from the dataset and be applied to the neural network model. The computing device 310 can receive the dataset, which is stored in a database, via communication network 330 and a communications system 318 or an input 320 of the computing device 310.

The computing device 310 can include an electronic processor 312, a set of input pins (i.e., input 320), a set of output pins, and a layout of circuit gates, which cause the electronic processor 312 to perform instructions, which are stored in a memory 314.

The computing device 310 can include a processor 312. In some embodiments, the processor 312 can be any suitable hardware processor or combination of processors, such as a central processing unit (CPU), a graphics processing unit (GPU), an application specific integrated circuit (ASIC), a field-programmable gate array (FPGA), a digital signal processor (DSP), a microcontroller (MCU), etc.

The computing device 310 can further include a memory 314. The memory 314 can include any suitable storage device or devices that can be used to store suitable data (e.g., the dataset, a trained neural network model, an optimized neural network model, etc.) and instructions that can be used by the processor 312. The memory 314 can include a non-transitory computer-readable medium including any suitable volatile memory, non-volatile memory, storage, or any suitable combination thereof. For example, memory 314 can include random access memory (RAM), read-only memory (ROM), electronically-erasable programmable read-only memory (EEPROM), one or more flash drives, one or more hard disks, one or more solid state drives, one or more optical drives, etc. In some embodiments, the processor 312 can execute at least a portion of process 400 or 500 described below in connection with FIG. 4 or 5.

The computing device 310 can further include a communications system 318. The communications system 318 can include any suitable hardware, firmware, and/or software for communicating information over the communication network 340 and/or any other suitable communication networks. For example, the communications system 318 can include one or more transceivers, one or more communication chips and/or chip sets, etc. In a more particular example, the communications system 318 can include hardware, firmware and/or software that can be used to establish a Wi-Fi connection, a Bluetooth connection, a cellular connection, an Ethernet connection, etc.

The computing device 310 can receive or transmit information (e.g., dataset 302, 304, a disease prediction indication 340, a trained neural network, etc.) and/or any other suitable system over a communication network 330. In some examples, the communication network 330 can be any suitable communication network or combination of communication networks. For example, the communication network 330 can include a Wi-Fi network (which can include one or more wireless routers, one or more switches, etc.), a peer-to-peer network (e.g., a Bluetooth network), a cellular network (e.g., a 3G network, a 4G network, a 5G network, etc., complying with any suitable standard, such as CDMA, GSM, LTE, LTE Advanced, NR, etc.), a wired network, etc. In some embodiments, communication network 330 can be a local area network, a wide area network, a public network (e.g., the Internet), a private or semi-private network (e.g., a corporate or university intranet), any other suitable type of network, or any suitable combination of networks. The communications links shown in FIG. 3 can each be any suitable communications link or combination of communications links, such as wired links, fiber optic links, Wi-Fi links, Bluetooth links, cellular links, etc.

In some examples, the computing device 310 can further include an output 316. The output 316 can include a set of output pins to output a prediction indication. In other examples, the output 316 can include a display to output a prediction indication. In some embodiments, the display 316 can include any suitable display devices, such as a computer monitor, a touchscreen, a television, an infotainment screen, etc. to display a report to a user which may be generated at various points, such as a report of potential neurons to be culled, a percentage reduction of processing caused by the culling, or other information regarding a step of pruning a trained model. In other embodiments, the display 316 can also provide a user with results of running the initial and/or pruned trained model, to provide (for example) the human activity indication 340, or any suitable result of a prediction/classification indication 340. Thus, a user can compare and contrast accuracy of the pruned model against the original model, such as by reserving a validation dataset.

In further examples, the disease prediction indication 340 or any other suitable indication can be transmitted to another system or device over the communication network 330. In further examples, the computing device 310 can include an input 320. The input can include a set of input pins to receive the dataset 302, 304. In other examples, the input 320 can include any suitable input devices (e.g., a keyboard, a mouse, a touchscreen, a microphone, etc.) and/or the one or more sensors that can produce the raw sensor data or the dataset 302, 304.

### Example Processes

FIG. 4 is a flow diagram illustrating an example pruning process 400. As described below, a particular implementation can omit some or all illustrated features/steps, may be implemented in some embodiments in a different order, and may not require some illustrated features to implement all embodiments. In some examples, a system (e.g., system 300 for optimization for a neural network model, etc.) in connection with FIG. 2 can be used to perform all or part of example process 400. However, it should be appreciated that other suitable processing hardware for carrying out the operations or features described below may perform process 400.

Process 400 includes high-level steps involved in an example proposed pruning process based on mean values of neuron activations. In some examples, process 400 may be used to identify and modify neurons, as well as update and prune the neural network's weights to achieve model optimization. In some examples, the accuracy of the pruned model may be used to assess the effectiveness of the pruning process, and an iterative process may be undertaken to balance resulting accuracy and pruning optimization.

At step 402, the process 400 may initialize a trained neural network model and parameters. In some examples, the trained neural network model can include a multilayer perceptron neural network model. However, it is contemplated that other types of neural networks can also be pruned using process 400, such as deep neural networks with multiple layers that may have feedforward characteristics and/or perform classification functions. The trained neural network model may have any number of neurons and/or layers. In some instances, the trained neural network model may be a generally-available multi-purpose pre-trained model (e.g., such as U-Net, ResNet, AlexNet, etc.), or a model that was previously trained or fine-tuned for a specific purpose (e.g., a custom MLP or CNN-based model). Further, the pretrained model may in some instances be pre-trained on a training dataset for a category of inputs (e.g., facial images, human activity, road signals for autonomous learning, etc.) rather than merely being general purpose.

At step 404, network profiling is performed with a simulation dataset. In some examples, the network is simulated with a simulation data set and the hidden layers' output values are gathered during the simulation. In some examples, the simulation dataset may correspond to portions of, or the complete, training dataset used during initial training of the neural network model (i.e., prior to step 402). In other examples, the training dataset may be a synthetic dataset that is developed so as to have common data characteristics as the original training dataset that was used to develop the trained neural network. For example, an entity applying process 400 to a trained neural network model may not have access to the dataset used to initially train the neural network model. Therefore, a synthetic dataset may be used. In some examples, the synthetic dataset may share one or more statistical metrics with the dataset used to initially train the neural network model, such as distribution of case/control examples, labeling schemes and ground truth labels, variability in data values, number of examples in the dataset, data density/filesize of the examples, etc. Similarly, the synthetic dataset may have common data characteristics as the original training data set in that the synthetic dataset may have a data composition that is generally of the same class as the original training dataset (e.g., similar signals (e.g., RF waveforms, LiDAR signals, etc.), similar image content, similar image type (e.g., optical vs. MRI), similar image streams, etc.).

Alternatively, the simulation dataset may be a new dataset that has common data characteristics as the original training dataset, but is purposely narrower in scope so as to cause the pruning process 400 to simultaneously achieve a fine-tuning of the neural network. For example, a neural network may have been originally trained to classify whether a human is present in an IoT device's camera images based on a training dataset comprising multiple images of humans in various environments as well as multiple images of environments lacking humans. However, if the IoT device will only be utilized in a security camera within a building, then the simulation dataset can include only images of indoor environments having/not having humans. Thus, the mean activation values and pruning that are performed as part of process 400 can be utilized to reduce and optimize the network in a way that fine tunes it and/or preserves its predictive power for the specific application in which it will be utilized. In this sense a user of process 400 may develop a robust trained neural network for recognition or classification tasks to be performed by the user's devices, and then can tailor how the network is pruned in a way that intelligently relates to a given customer's use case.

At step 406, the mean values of the activations of the neurons of the hidden layer during the simulation are calculated. In some examples, after the forward pass, the mean values of the activations of each neuron in the hidden layer are calculated. These mean values may represent the average activation level of each neuron across all input samples. In some examples, the mean value may be calculated using a script or function stored on a memory (e.g., memory 314) and executed by a processor (e.g., processor 312).

At step 408, neurons are identified based on the mean values of their activations. Neurons in the hidden layer may be identified based on the mean values of their activations. In some examples, neurons with mean values near −1, 0, and 1 are identified. For example, mean values ranging from 0.8 to 1 may be identified as neurons with values near 1, and mean values ranging from −0.8 to −1 may be identified as neurons with values near −1. In some examples, a user may specify a value range corresponding to the identification of the mean values of neuron activations. For example, the specified value range may be adjusted based on a desired accuracy and/or any computational restraints.

At step 410, the neurons are modified. In some examples, the neurons identified in step 408 are modified based on their classification. For example, neurons marked as “Neurons near −1” are approximated to −1, neurons marked as “Neurons near 0” are approximated to 0, and neurons marked as “Neurons near 1” are approximated to 1. A modification value for each neuron that is a “Neuron near 1” may be determined based on the neurons' corresponding output weight and classification. For example, neurons with a mean activation near ‘1’ may have an associated modification value determined by subtracting the corresponding output weights from the original bias value. Thus, in some examples, each neuron to be modified and each modification value may be associated as a unique pair; in other examples, neurons within a given range grouping may have the same modification value. Moreover, for example, neurons with a mean activation near ‘0’ may have their weights added during modification. The modification values may be determined so as to cause neurons that initially had activation values near 1, to behave in future processing as though they do in fact have activation values equal to 1; and similarly to cause neurons that initially had activation values near −1 to in fact have activation values equal to −1. In some examples, the modification of the neurons allows the network to remain stable and maintain its accuracy.

At step 412, the weights corresponding to the pruned neurons are pruned. For example, the weights may be removed from the neural network to reduce the complexity of the model. In particular, in some examples, the effect of each neuron may be identified for pruning. The corresponding neurons may be nullified by setting their output value to zero when performing a forward pass of the model. In some examples, the pruning of these neurons may remove their contribution to subsequent computations, without altering the network's architecture. For example, setting a neuron's output to zero may stimulate non-participation in the forward propagation process.

At step 414, the pruned model is evaluated. In some examples, the pruned neural network may be evaluated using a test dataset to determine its accuracy and performance. For example, when the pruned neural network includes breast cancer data, the accuracy may correspond to a confidence level of the network's ability to predict and/or indicate breast cancer in a patient.

At step 416, the pruned model's accuracy may be outputted. In some examples, the output can include a disease prediction indication corresponding to an accuracy or confidence level of the model. For example, the output can include a percentage, a binary indication (sick or heathy), a symbol, one of multiple classes or gravity level of the disease, or any other suitable indication. In further examples, the output can be shown via output 316 of the device 310 or transmitted to other system via the communication network 330 in FIG. 3.

### Examples and Experiments

Described below are experimental setups and validations of the disclosed system and methodology. In some examples, the approach described herein identified neurons for removal based on their activation profiles during inference. The method may operate using activation profiling, threshold determination and neuron approximation, interference optimization, and weight pruning.

Activation profiling involves profiling neurons during inference across the test set. Specifically, the mean activation values for each neuron in the hidden layer is calculated. Threshold determination and neuron approximation involves pruning neurons exhibiting specific activation characteristics based on defined threshold values. In some examples, neurons are classified into three categories: (1) Near −1 Neurons (i.e., neurons that are consistently close to −1 during inference are considered dormant and are pruned by setting their activations to −1), (2) Near 0 Neurons (i.e., neurons with activations near 0 that are identified as redundant and are pruned by setting their activations to 0), and (3) Near 1 Neurons (i.e., neurons that maintain activations close to 1 are preserved as informative). Inference Optimization involves employing the pruned model, with the identified neurons modified according to their categories, for subsequent inference. Weight Pruning involves setting the weights associated with the pruned neurons to the approximated values.

The inventors gathered experimental results and performed analyses that provided insights into the performance and efficiency of the proposed methodology for neural network optimization, quantization, and pruning. The experimental results were obtained on MLP network models trained on MNIST dataset, as well as real-world datasets such as Breast Cancer Wisconsin. The analyses comprised performing a comprehensive evaluation encompassing various aspects, including model accuracy, the number of neurons pruned, and the quantization of weights to reduced bit precision. The term original model denotes the baseline model without any optimization, while pruned model accuracy signifies the accuracy achieved after applying the Tanh-based pruning method. quantized model accuracy refers to the performance of the model when the optimization technique is applied after the baseline model parameters are quantized to lower precision.

The Breast Cancer dataset was derived from the Breast Cancer Wisconsin (Diagnostic) dataset, obtained from the UCI Machine Learning Repository. It comprises features extracted from digitized images of breast cancer biopsies, such as mean radius, texture, and smoothness. The dataset is binary-classified, with each sample being categorized as either malignant or benign based on pathological findings. The MLP model has one input layer with 30 input features, one hidden layer with ten neurons, and the output layer with one neuron that implements binary classification with sigmoid.

FIG. 5 shows five models, comparing the accuracy for the breast cancer dataset. From FIG. 5, the proposed Tanh-based pruning method focuses on the impact of optimization techniques: pruning and quantization. Three model variants were compared: the original model 502, the pruned model 504, and the quantized model 506. The original model 502 consistently achieved the highest accuracy, with an average of 94.72%. The pruned model 504, which underwent neuron pruning to reduce complexity, often outperformed the original model 502, demonstrating the technique's effectiveness without accuracy compromise.

In contrast, the quantized model 506 consistently had the lowest accuracy, averaging 81.57%, highlighting the trade-off between memory efficiency and accuracy. The increased accuracy gap between the original model 502 and the quantized model 506 implies that the quantization process introduced noise. Quantization, by reducing the precision of weights and activations, complicates the model's ability to capture fine-grained details in the data. This complexity contributes to a potential loss of accuracy.

The MNIST dataset is a widely recognized and extensively used benchmark dataset in the field of machine learning and computer vision. It comprises a vast collection of 28×28 pixel grayscale images of handwritten digits ranging from 0 to 9. MNIST dataset is originally derived from the National Institute of Standards and Technology (NIST) dataset. The architecture of this MLP comprises an input layer, a hidden layer, and an output layer. The input layer of the MLP is configured to accommodate flattened 28×28 pixel grayscale images. It has an input dimensionality of 784 (28×28), representing each pixel's intensity value. The hidden layer is composed of 50 neurons. To introduce non-linearity and enable complex feature learning, the hyperbolic tangent activation function (tanh) is employed. The output layer is constructed with ten neurons, aligning with the ten possible digit classes (0-9). The softmax activation function is utilized here to convert the raw output into class probabilities. The digit class with the highest probability is selected as the model's prediction.

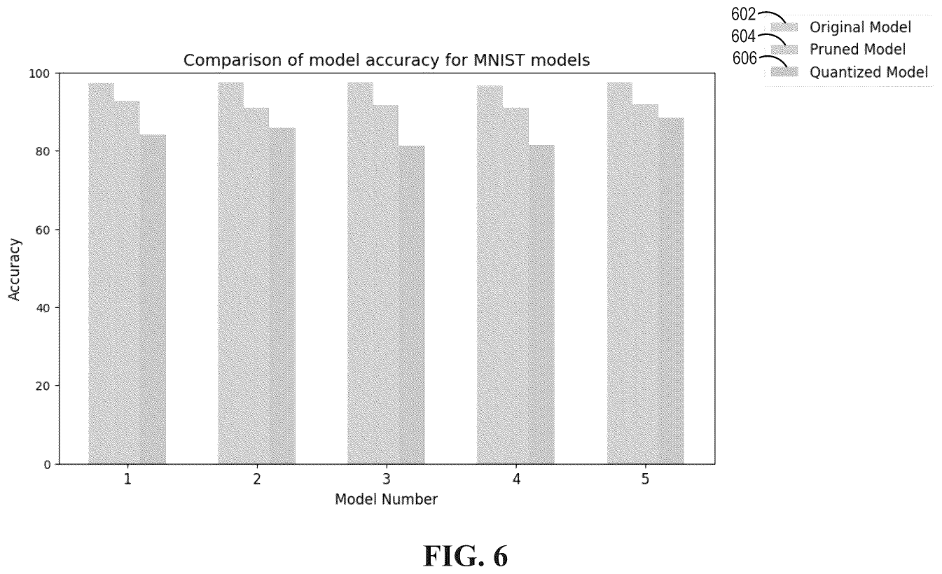

FIG. 6 compares five MLP model variants applied to the MNIST dataset. The graph offers a detailed comparison of model performance across various configurations for MNIST digit classification. It discerns that the original model 602 consistently outperforms both the pruned model 604 and the quantized model 606 in terms of accuracy, averaging 97.32%. The pruned and quantized models 604, 606, aimed to reduce the model complexity and computational demands, exhibit slightly lower accuracy values. The accuracy loss between the original and quantized models 602, 606 is greater than between the pruned and original models 604, 602. The precision reduction in weights and activations due to quantization can alter the distribution of activation values within the network. This directly impacts the pruning task, making it more challenging to identify and remove less distinctive neurons.

TABLE 1
Comparison of the number of neurons pruned in original,
prunes, and quantized MLP modes.

| | | # of | accuracy of | # | | accuracy of |
|---|---|---|---|---|---|---|
| | | neurons | original model | neurons | % of neurons | pruned model |
| Dataset | Exp# | original | (%) | pruned | pruned | (%) |
| MNIST | 1 | 50 | 97.27 | 14 | 28 | 92.78 |
| | 2 | 50 | 97.52 | 18 | 36 | 91.12 |
| | 3 | 50 | 97.53 | 14 | 28 | 91.67 |
| | 4 | 50 | 96.77 | 16 | 32 | 91.05 |
| | 5 | 50 | 97.54 | 19 | 38 | 91.97 |
| Average | | | 97.32 | 16 | 32.40 | 91.71 |
| BC | 1 | 10 | 94.28 | 9 | 90 | 94.37 |
| | 2 | 10 | 95.38 | 7 | 70 | 95.6 |
| | 3 | 10 | 94.06 | 9 | 90 | 94.2 |
| | 4 | 10 | 96.04 | 9 | 90 | 95.95 |
| | 5 | 10 | 93.84 | 7 | 70 | 93.67 |
| Average | | | 94.72 | 8 | 82 | 94.75 |
| | | (%) loss in | # neurons | | accuracy of | loss in |
| | | accuracy | pruned in | % of | quantized | accuracy |
| Dataset | Exp# | pruned | quantized | neurons | model (%) | quantized (%) |
| MNIST | 1 | 4.49 | 13 | 26 | 84.2 | 13.07 |
| | 2 | 6.4 | 19 | 38 | 85.84 | 11.68 |
| | 3 | 5.86 | 17 | 34 | 81.24 | 16.29 |
| | 4 | 5.72 | 13 | 26 | 81.52 | 15.25 |
| | 5 | 5.57 | 16 | 32 | 88.46 | 9.08 |
| Average | | 5.60 | 15 | 31.20 | 84.25 | 13.07 |
| BC | 1 | −0.09 | 9 | 90 | 78.94 | 15.34 |
| | 2 | −0.22 | 7 | 70 | 85.96 | 9.42 |
| | 3 | −0.14 | 9 | 90 | 80.7 | 13.36 |
| | 4 | 0.09 | 9 | 90 | 79.82 | 16.22 |
| | 5 | 0.17 | 7 | 70 | 82.45 | 11.39 |

| | | | | | |
|---|---|---|---|---|---|
| Average | −0.03 | 8 | 82 | 81.57 | 13.14 |

Table 1 summarizes the results of five experiments involving pruning and quantization. It tabulates the number of neurons pruned from the original model, the accuracy of the original model, the accuracy of the pruned model, and the accuracy after quantization. The accuracy of the original model for the MNIST dataset is consistently high. However, after pruning, there is a noticeable drop in accuracy, indicating that aggressive pruning can result in significant accuracy loss. Tanh-based unstructured pruning of the MNIST dataset, the average accuracy of the pruned models is 91.71%, with an average loss in accuracy of 5.60% compared to the original model, indicating that pruning effectively reduced complexity with minimal accuracy compromise. This suggests that, on average, the pruned models are able to maintain a relatively high level of accuracy despite a reduction in the number of neurons. In the Breast Cancer dataset, the average accuracy of the pruned models is 94.75%, with a negligible average loss in accuracy of −0.03% compared to the original models. The minimal loss in accuracy indicates that pruning has a less detrimental effect on the performance of the models on the Breast Cancer dataset.

These findings present a more substantial neuron reduction resulting in computational resources utilized to be saved. In particular, an 82% savings is seen. Across both datasets, the percentage of neurons pruned in the pruned models is consistent, with averages of 32.40% for MNIST and 82% for Breast Cancer. This underscores the trade-off between model complexity and accuracy and highlights the need for careful model selection, considering resource constraints and specific use-case requirements.

Comparing the quantized model to the pruned model, some quantized models exhibited fewer neurons pruned while retaining competitive accuracy. The average loss in accuracy for the MNIST classification is 13.07%, and for the Breast Cancer classification, 13.14%. The observed accuracy loss in the breast cancer dataset can be attributed to the noise introduced by quantization. The quantization process, involving rounding errors, introduces inaccuracies that accumulate and impact the model's accuracy to discern subtle patterns. For the MNIST dataset, quantization reduced the number of neurons by an average of 32.40%. Examining the impact of pruning, it was found that, for most Breast Cancer models, the number of pruned neurons was modest, ranging from 7 to 9, indicating that most of the network's structure is pruned. Quantization reduced the number of neurons by an average of 82%. It can be observed that quantization consistently compromises accuracy. A pruning technique was employed based on the hyperbolic tangent (tanh) activation function to optimize the MLPs. The proposed pruning methodology substantially reduced the number of neurons while preserving accuracy. These results provide evidence for the effectiveness of the proposed approach in reducing model complexity and computational demands.

In the foregoing specification, implementations of the disclosure have been described with reference to specific example implementations thereof. It will be evident that various modifications may be made thereto without departing from the broader spirit and scope of implementations of the disclosure as set forth in the following claims. The specification and drawings are, accordingly, to be regarded in an illustrative sense rather than a restrictive sense.

1. A method for optimizing a trained neural network model, the method comprising:
obtaining a trained neural network model, the trained neural network model comprising a plurality of neurons and a plurality of hidden layers;
determining a simulation dataset having a set of data characteristics common to data characteristics of a training dataset on which the trained neural network was trained
receiving a plurality of output information of the hidden layers by running the trained neural network on a simulation dataset, wherein the output information is indicative of activations of the neurons while running on the simulation dataset;
calculating a plurality of mean activation values corresponding to the plurality of outputs information, the mean activation values having been determined according to a hyperbolic tangent (tanh) activation function;
determining a subset of the plurality of neurons for which the mean activation values corresponded to one of at least two ranges of activation values;
modifying the subset of the plurality of neurons and a plurality of associated layers corresponding to the subset of the plurality of neurons; and
generating an optimized neural network model that implements the modified plurality of neurons and the modified plurality of associated layers as well as neurons of the trained neural network that were not modified.

2. The method of claim 1, further comprising determining a modification value associated with each of the subset of the plurality of neurons, and wherein modifying the subset of the plurality of neurons includes modifying each associated neuron of the subset according to its associated modification value.

3. The method of claim 2, wherein the at least two ranges comprises:
a first range of 0.8 to 1; and
a second range of −1 to −0.8.

4. The method of claim 2, wherein the modification values are determined so as to cause the associated neuron of the subset of the plurality of neurons to behave as though the associated neuron has a mean activation value of 1 or −1.

5. The method of claim 1, wherein the simulation dataset is part of the training dataset used to initially train the trained neural network model.

6. The method of claim 1, wherein the simulation dataset is a synthetic dataset.

7. The method of claim 3, wherein modifying the plurality of neurons and the plurality of associated layers corresponding to the subset of mean values comprises:
updating neurons in the subset of the plurality of neurons that fall within the first range to have mean activation values of 1; and
updating neurons in the subset of the plurality of neurons within the second range to have mean activation values of −1.

8. The method of claim 1, further comprising pruning neurons with mean activation values of 0.

9. The method of claim 6, wherein pruning neurons with mean activation values of 0 comprises setting their output value to zero.

10. The method of claim 3, further comprising determining an accuracy associated with the optimized neural network model when run on simulation data, and iteratively adjusting at least one of the first range or the second range to reach a desired accuracy level and desired pruning level.

11. The method of claim 1, wherein the set of data characteristics comprises at least one of:
a ground truth labeling approach;
a statistical distribution of case and control examples corresponding to outputs of the trained neural network; or
data composition.

12. A system for neural network optimization, the system comprising:
an electronic processor, and
a non-transitory computer-readable medium storing machine-executable instructions, which, when executed by the electronic processor, cause the electronic processor to:
obtain a trained neural network model, the trained neural network model comprising a plurality of neurons and a plurality of hidden layers;
determine a simulation dataset having a set of data characteristics common to data characteristics of a training dataset on which the trained neural network was trained
receive a plurality of output information of the hidden layers by running the trained neural network on a simulation dataset, wherein the output information is indicative of activations of the neurons while running on the simulation dataset;
calculate a plurality of mean activation values corresponding to the plurality of outputs information, the mean activation values having been determined according to a hyperbolic tangent (tanh) activation function;
determine a subset of the plurality of neurons for which the mean activation values corresponded to one of at least two ranges of activation values;
modify the subset of the plurality of neurons and a plurality of associated layers corresponding to the subset of the plurality of neurons; and
generate an optimized neural network model that implements the modified plurality of neurons and the modified plurality of associated layers as well as neurons of the trained neural network that were not modified.

13. The system of claim 12, wherein the trained neural network model is a multilayer perceptron neural network model.

14. The system of claim 12, wherein the simulation dataset is a synthetic dataset.

15. The system of claim 12, wherein the simulation dataset comprises a distribution of classes common to the training dataset on which the trained neural network was trained.
